(19) United States
(12) Patent Application Publication
(10) Pub. No.: US 2025/0328040 A1
(43) Pub. Date: Oct. 23, 2025

(54) VEHICLE WINDOW

(71) Applicant: Webasto SE, Stockdorf (DE)

(72) Inventors: Ziad TOUKABRI, Stockdorf (DE); Dominik BAUER, Stockdorf (DE); Markus Walter POHLEN, Stockdorf (DE)

(21) Appl. No.: 19/185,983

(22) Filed: Apr. 22, 2025

(30) Foreign Application Priority Data
Apr. 23, 2024 (DE) 10 2024 111 353.7

(51) Int. Cl. G02F 1/1333; B32B 17/10; B60J 1/00; B60J 3/00; B60J 3/04; G02F 1/1335

(52) U.S. Cl. CPC G02F 1/133305; B32B 17/10036; B32B 17/10174; B32B 17/10357; B32B 17/10504; B32B 17/10743; B32B 17/10779; B60J 1/001; B60J 3/007; B60J 3/04; G02F 1/133514; B32B 2605/00; G02F 2202/28

(57) ABSTRACT

A vehicle window, in particular, for a vehicle roof, having a composite structure with a window outer body and a window inner body and an electrically switchable shading device, which is inserted between the outer body of the window and the inner body of the window and two plastic films, each with a electrically conductive coating, and a liquid crystal layer, which is placed between the two plastic films. Between the shading device and the outer body of the window and between the shading device and the inner body of the window at least one additional plastic film and one layer each of optically clear adhesive and at least one of the Layers of optically clear adhesive are colored.

### CROSS-REFERENCE TO RELATED APPLICATION(S)

This application claims the benefit of German Application No. DE 10 2024 111 353.7, filed Apr. 23, 2024, which is incorporated herein by reference in its entirety.

### TECHNICAL FIELD

This disclosure relates generally to a vehicle window which has a composite structure with a window outer body and a window inner body and also an electrically switchable shading device. The electrically switchable shading device is arranged between the window outer body and the window inner body.

### BACKGROUND

A vehicle window having a switchable shading device may be, in particular in the region of a vehicle roof, a fixed roof element or an adjustable cover element of a roof opening system. The vehicle window is in the form of a composite component which comprises a window outer body that faces the vehicle surroundings, and a window inner body that faces the vehicle interior and forms an inner visible face of the vehicle window. Arranged between the window inner body and the window outer body is a shading device which comprises an electrically switchable liquid crystal layer, in particular an electrically switchable polymer-dispersed liquid crystal layer, i.e. a so-called PDLC layer. The liquid crystal layer is arranged between two films, on the respective inner sides of which transparent electrodes are arranged. Via the electrodes, the liquid crystal layer is switchable between a transmitting state and a blocking state. To adapt to the appearance of the vehicle, colored glass, for example, for the window inner body or the window outer body, or colored adhesive films may be used. The inclusion of colored films or the like in the composite structure can result in clouding of the vehicle window. The large number of layers of the composite structure, which may also comprise colored intermediate layers, makes it complex to manufacture and thus may result in high manufacturing costs.

### SUMMARY

The invention addresses the problem of creating a vehicle window with an electrically switchable shading device, which is characterized by high optical neutrality and has a layer structure which exhibits high functionality while having few layers to handle during lamination of the composite glazing.

This problem is solved according to the invention by the vehicle window having the features of claim 1.

Therefore, according to the invention, a vehicle window, in particular a window of a vehicle roof, is proposed, which comprises a composite structure with a window outer body, a window inner body and an electrically switchable shading device. The electrically switchable shading device is arranged between the window outer body and the window inner body and comprises two plastics films and a liquid crystal layer. The two plastics films are each provided with an electrically conductive coating. The liquid crystal layer is arranged between the two plastics films. Between the shading device and the window outer body and between the shading device and the window inner body, respectively, at least one further plastic film and a layer made of optically clear adhesive are arranged. At least one of the layers made of optically clear adhesive is provided with a coloring.

As a result of the coloring of at least one of the layers made of optically clear adhesive, an optically appealing appearance of the vehicle window can be created, which is compatible with a large number of vehicle designs.

Furthermore, as a result of the coloring of at least one of the layers made of optically clear adhesive, it may be possible to dispense with a colored window inner body to adapt the vehicle window to the vehicle design.

The transmittance of the composite structure for visible light may be low both in the transmitting state and in the blocking state of the liquid crystal layer, and this also results in low light transmission through the vehicle window into the vehicle interior. The desired light transmission levels may be adjusted for with tinting of the optically clear adhesive. For example, the tinting can be increased or decreased relatively to provide a desired light transmission of the window construction.

By way of example, the two layers made of optically clear adhesive are provided with a coloring.

The layer made of optically clear adhesive provided with the coloring may be characterized in particular by strong absorption of electromagnetic radiation and a wavelength range between 350 nm and 2500 nm. For visible light, the transmittance may preferably be under 30%. Even for infrared radiation in the range between 700 nm and 2500 nm, the transmittance can be under 40%.

The coloring of at least one of the layers made of optically clear adhesive may be defined in the color space in particular by the color coordinates L, a and b, wherein L<30, −15 a<15 and −15<b<15.

In a preferred embodiment of the vehicle window according to the invention, the coloring comprises color particles which have been taken up by the adhesive and are preferably formed from ceramic nanoparticles.

In an exemplary embodiment of the vehicle window according to the invention, the coloring comprises a, preferably organic, dye which has been mixed into the adhesive.

In a preferred embodiment of the vehicle window according to the invention, the coloring comprises a color coating of the adhesive.

The layer made of optically clear adhesive, which is provided with the coloring, has, for example, a thickness of between 0.5 μm and 50 μm, in particular between 0.5 μm and 25 μm.

In a preferred embodiment of the vehicle window according to the invention, the optically clear adhesive is an acrylate adhesive.

In an exemplary embodiment of the vehicle window according to the invention, the coloring is a black coloring.

The term “black coloring” should be understood in its broadest meaning in the present case, and includes deep black and dark gray coloring states.

As a result of the coloring of at least one of the layers made of optically clear adhesive, it is possible, for example, to reduce the transmittance for visible light which is directly incident on the vehicle window to values of at most 8% in the blocking state of the liquid crystal layer. In the transmitting state of the liquid crystal layer, the transmittance for visible light lies, for example, in a range between 1% and 30%, preferably 1% to 15%, more preferably 3% to 10%.

The transmittance for, in particular visible, light is measured for example in accordance with ISO 13837:2021 (5.3.1), in particular with the illuminant A and an observer angle of 2 degrees.

The optically clear adhesive layers adjoin other materials, for example the PET layers. Light refraction and reflection occur at this boundary layer on account of different refractive indices. For thin adhesive layers, undesired rainbow effects may arise as a result of the superimposition of direct and reflected rays. To prevent these effects, the refractive index of the optically clear adhesive layer can be adapted to the refractive index of the adjacent PET layer or adjacent PET layers. In particular, the difference of the refractive index of the optically clear adhesive layer from the PET layer may be less than 0.2, preferably less than 0.1, more preferably less than 0.05.

The plastics films may in particular be in the form of PET (polyethylene terephthalate) film, COP (cyclic olefin polymer) film or of PC (polycarbonate) film.

In an exemplary embodiment of the vehicle window according to the invention, the plastics films of the shading device are PET films.

The plastics films expediently have on their respective inner sides an electrically conductive layer such that the adjoining liquid crystal layer is adjustable by changing the electric field between the blocking state and the transmitting state.

The electrically conductive coating is made, for example, of ITO (indium tin oxide) or PEDOT:PSS.

The liquid crystal layer is, for example, a polymer-dispersed liquid crystal layer (PDLC layer). The transmitting state may be reached by applying a voltage to the electrically conductive coatings adjacent to the liquid crystal layer, and the blocking state may be a state without voltage.

The liquid crystal layer may be a PNLC (polymer network liquid crystal) layer, in which the transmitting state is brought about by applying a voltage and the blocking state exists in the absence of voltage.

Alternatively, the liquid crystal layer may be a layer in which a voltage is applied in each switched state. It is then a so-called inverse, bistable PDLC layer.

Furthermore, it is possible to design the liquid crystal layer such that it can be switched in a segmented manner and/or adjusted continuously between the transmitting state and the blocking state. Segmentation can be achieved by providing at least one of the electrically conductive coatings with separation to provide electrically isolated segments. Such separation can be formed, for example, by local removal of the electrically conductive coating. Preferably, such removal may include linear removal of the coating by a laser.

The liquid crystal layer may be provided with a pattern.

The further plastic films may be in the form of PET (polyethylene terephthalate) film, COP (cyclic olefin polymer) film or of PC (polycarbonate) film. Preferably the further plastic films are PET films and more preferably, the further plastic films are the same material as the plastic films of the shading device.

In a preferred embodiment of the vehicle window according to the invention, the window inner body and the window outer body each contacts a polymer adhesive layer which contacts a respective one of the further plastics films of the composite structure, in particular more directly.

The polymer adhesive layers are formed, for example, from a thermoplastic polyurethane (TPU), ethylene vinyl acetate (EVA), polyvinyl butyral (PVB), an epoxide, silicone, polyethylene or from some other transparent plastics film.

The polymer adhesive layers are, for example, heat-activated layers, or are heat activated during the production of the vehicle window.

The optically clear adhesive of the layers made of optically clear adhesive is, for example, not a heat-activated adhesive, or the optically clear adhesive is not heat activated during the production of the vehicle window.

The refractive index of the polymer adhesive layers is preferably in the range of that of the window inner body and of the window outer body, respectively, and has, for example, a value of approximately 1.5.

In an exemplary embodiment of the vehicle window according to the invention, the window inner body and/or the window outer body (each) border(s) a polymer adhesive layer which borders a respective one of the further plastics films.

In a preferred embodiment, the vehicle window according to the invention comprises two further layers made of optically clear adhesive.

The two further layers made of optically clear adhesive are, for example, each arranged between the shading device and a respective one of the layers made of optically clear adhesive.

In an exemplary embodiment of the vehicle window according to the invention, the further layers made of optically clear adhesive are free of a coloring.

It is likewise conceivable for one or both of the further layers made of optically clear adhesive to be provided with a coloring.

In a preferred embodiment, the vehicle window according to the invention comprises four further plastics films, wherein the layers made of optically clear adhesive are each arranged between two further plastics films.

In a specific embodiment of the vehicle window according to the invention, the window inner body and the window outer body are each formed in a curved manner, specifically in the window longitudinal direction and/or in the window transverse direction. The radius of curvature defining the curve may vary in the respective direction and have, for example, a value of between 1000 mm and 10 000 mm, in particular between 2000 mm and 5000 mm. The shading device may follow the curves.

The window outer body and the window inner body of the vehicle window according to the invention may be manufactured from clear glass or some other suitable glass or from a plastics material such as polycarbonate.

The window outer body and/or the window inner body of the vehicle window according to the invention (each) comprise(s), for example, a coating. The coating may be or comprise a light-reflective coating, for example an infrared-reflective coating, and/or a coating with a low emissivity.

In a specific embodiment, the window inner body may also be formed from, or comprise, a hard, impact-and scratch-resistant coating which is formed on a side of the PDLC arrangement that faces away from the window outer body.

### BRIEF DESCRIPTION OF DRAWINGS

Exemplary embodiments of a vehicle window according to the invention are illustrated in a schematically simplified manner in the drawing and are explained in more detail in the following description. In the drawing:

FIG. 1 shows a schematic plan view of a vehicle roof having a vehicle window according to the invention;

FIG. 2 shows a schematic section through the vehicle window in an unconnected state of individual layers of the vehicle window; and

FIG. 3 shows a section through a further vehicle window according to the invention in an unconnected state of individual layers of the further vehicle window.

### DETAILED DESCRIPTION

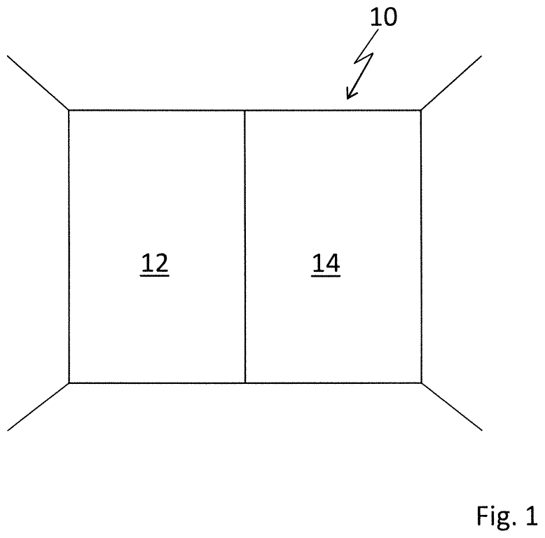

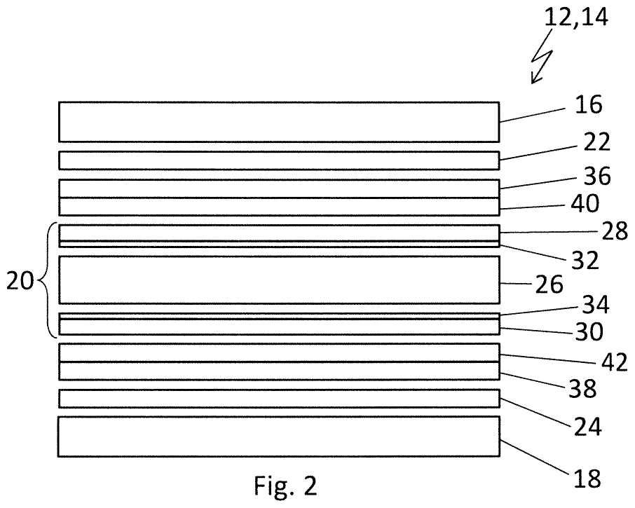

FIG. 1 shows a vehicle roof 10 of a motor vehicle that is otherwise not illustrated in detail. The vehicle roof 10 is a panoramic roof, which has an adjustable cover element 12 and a fixed roof element 14 which is fixedly or immovably connected to the vehicle body. The cover element 12 and the fixed roof element 14 are each in the form of a glass element and thus in the form of a vehicle window. They have the same layer structure, which is illustrated in a sectional view in FIG. 2.

Alternatively, rather than the roof element, the vehicle roof may have a second fixed roof element or, rather the fixed roof element and the roof element, it may have a single fixed roof element.

The roof elements 12 and 14, which are each in the form of a vehicle window, each represent a composite component which comprises a window outer body 16 and a window inner body 18. The window outer body 16 and the window inner body 18 are each manufactured, for example, from soda lime clear glass.

The window outer body 16 faces the vehicle surroundings, whereas the window inner body 18 faces the vehicle interior and forms an inner visible face of the vehicle roof 10.

Arranged between the window outer body 16 and the window inner body 18 is a shading device 20, which is attached to the window outer body 16 via an outer polymer adhesive layer 22 or an adhesive and to the window inner body 18 via an inner polymer adhesive layer 24 or an adhesive.

The shading device 20 is a PDLC arrangement and comprises a liquid crystal layer 26 in the form of a PDLC layer, which is bordered on each of its two sides by a plastics film 28 and 30, respectively, made of PET. Arranged on each of the sides of the plastics films 28 and 30 that face the shading device 20 is an electrically conductive coating 32 and 34, respectively. By means of the electrically conductive coatings 32 and 34, a voltage can be applied to the liquid crystal layer 26 such that the liquid crystal layer 26 is adjustable between a blocking state and a transmitting state.

On the sides of the plastics films 28 and 30 that face away from the liquid crystal layer 26, the plastics films 28 and 30 are each adjoined by a layer 40 and 42, respectively, made of optically clear adhesive, in particular of acrylate adhesive. The optically clear adhesive is, for example, not a heat-activated adhesive.

The layers 40 and 42 made of optically clear adhesive each have a coloring, in particular a black coloring. The layers 40 and 42 each have a thickness of between 0.5 μm and 50 μm, in particular between 0.5 μm and 25 μm.

It is likewise conceivable for only one of the layers 40 and 42 made of optically clear adhesive to have a coloring, wherein, in this case, at least the layer 40 or 42 of the layers 40 and 42 made of optically clear adhesive that is provided with the coloring has a thickness of between 0.5 μm and 50 μm, in particular between 0.5 μm and 25 μm.

The coloring comprises color particles which have been taken up by the adhesive and are preferably formed from ceramic nanoparticles.

It is likewise conceivable for the coloring to comprise an, in particular organic, dye which has been mixed into the adhesive, and/or for the coloring to comprise a color coating of the adhesive.

Provided between each of the layers 40 and 42 made of optically clear adhesive and the window outer body 16 and the window inner body 18, respectively, is a further plastics film 36 and 38, respectively, made of PET. The further plastics film 36 and 38 is in each case connected to the window outer body 16 and the window inner body 18, respectively, via the polymer adhesive layer 22 and 24, respectively.

The liquid crystal layer 26 can be switched such that, in the blocking state, in which no voltage is applied to the electrically conductive layers 32 and 34, it has a transmittance for visible light of less than 8%. In the transmitting state, in which a voltage is applied to the electrically conductive layers 32 and 34, the roof elements 12 and 14, as a result of the coloring of the layers 40 and 42 made of optically clear adhesive, are transmissible for visible light such that a proportion of at most 30% passes through.

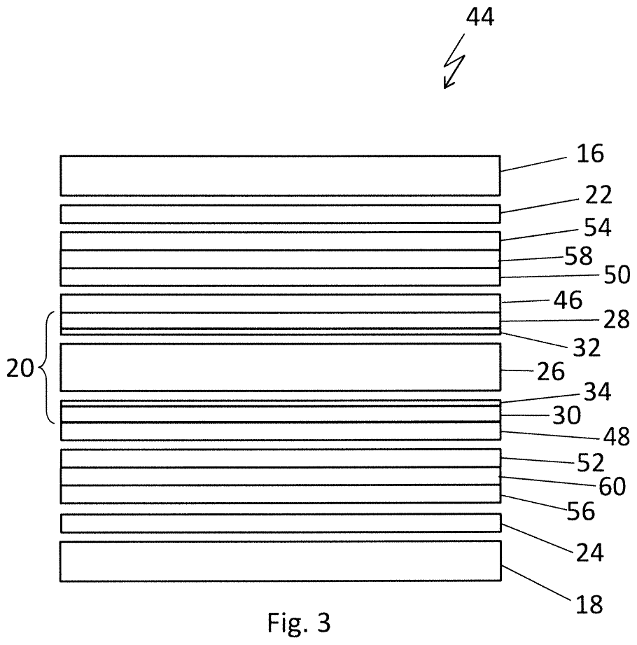

FIG. 3 illustrates a section through a further vehicle window 44 according to the invention. The structure of the further vehicle window 44 corresponds substantially to the structure of the vehicle windows that are configured as a cover element 12 and as a fixed roof element 14, respectively, and are shown in FIGS. 1 and 2. Therefore, in the following text, only the differentiating features are explained. Otherwise, the above information applies, mutatis mutandis.

Rather than the layers 40 and 42 made of optically clear adhesive that are provided with the coloring, the further vehicle window 44 comprises two layers 58 and 60 made of optically clear adhesive, which are each embedded between two further plastics films 50 and 52, and 54 and 56, respectively, and are arranged between the window outer body 16 and the shading device 20, and the window inner body 18 and the shading device 20, respectively. The layers 58 and 60 each have a thickness of between 0.5 μm and 50 μm, in particular a thickness of between 0.5 μm and 25 μm.

It is likewise conceivable for only one of the layers 58 and 60 made of optically clear adhesive to have a coloring, wherein, in this case, at least the layer 58 or 60 of the layers 58 and 60 made of optically clear adhesive that is provided with the coloring has a thickness of between 0.5 μm and 50 μm, in particular between 0.5 μm and 25 μm.

The coloring of the layers 58 and 60 made of optically clear adhesive corresponds to the coloring of the layers 40 and 42 made of optically clear adhesive, and for this reason, reference is made to the above information.

The further vehicle window 44 also comprises two further layers 46 and 48 made of optically clear adhesive, which each adjoin the side of a respective one of the plastics films 28 and 30, respectively, that faces away from the liquid crystal layer 26. The two further layers 46 and 48 made of optically clear adhesive are free of a coloring or do not have a coloring.

It is likewise conceivable to also provide the two further layers 46 and 48 made of optically clear adhesive or one of the two further layers 46 and 48 made of optically clear adhesive with a coloring.

### LIST OF REFERENCE SIGNS

10 Vehicle roof
12 Cover element
14 Fixed roof element
16 Window outer body
18 Window inner body
20 Shading device
22 Polymer adhesive layer
24 Polymer adhesive layer
26 Liquid crystal layer
28 Plastics film
30 Plastics film
32 Electrically conductive coating
34 Electrically conductive coating
36 Further plastics film
38 Further plastics film
40 Layer made of optically clear adhesive
42 Layer made of optically clear adhesive
44 Further vehicle window
46 Further layer made of optically clear adhesive
48 Further layer made of optically clear adhesive
50 Further plastics film
52 Further plastics film
54 Further plastics film
56 Further plastics film
58 Layer made of optically clear adhesive
60 Layer made of optically clear adhesive

1. A vehicle window comprising a composite structure with a window outer body and a window inner body and also an electrically switchable shading device which is arranged between the window outer body and the window inner body and comprises:
two plastics films which are each provided with an electrically conductive coating, and
a liquid crystal layer which is arranged between the two plastics films,
wherein, between the shading device and the window outer body and between the shading device and the window inner body, respectively, at least one further plastics film and a layer made of optically clear adhesive are arranged, and
at least one of the layers made of optically clear adhesive is provided with a coloring.

2. The vehicle window as claimed in claim 1, wherein the coloring comprises color particles which have been taken up by the adhesive.

3. The vehicle window as claimed in claim 1, wherein the coloring comprises a dye which has been mixed into the adhesive.

4. The vehicle window as claimed in claim 1, wherein the coloring comprises a color coating of the adhesive.

5. The vehicle window as claimed in claim 1, wherein the layer made of optically clear adhesive, which is provided with the coloring, has a thickness of between 0.5 μm and 50 μm.

6. The vehicle window as claimed in claim 1, wherein the optically clear adhesive is an acrylate adhesive.

7. The vehicle window as claimed in claim 1, wherein the coloring is a black coloring.

8. The vehicle window as claimed in claim 1, wherein the coloring is designed such that the composite structure has a transmittance for visible light of less than 30% in a transmitting state of the shading device and has a transmittance for visible light of at most 8% in a blocking state of the shading device.

9. The vehicle window as claimed in claim 1, wherein the plastics films and/or the further plastics films of the shading device is or are (a) PET film(s).

10. The vehicle window as claimed in claim 1, wherein the liquid crystal layer is a PDLC layer.

11. The vehicle window as claimed in claim 1, wherein the window inner body and the window outer body each border a polymer adhesive layer which borders the respective further plastics film of the composite structure.

12. The vehicle window as claimed in claim 1, which has two further layers made of optically clear adhesive.

13. The vehicle window as claimed in claim 12, wherein the two further layers made of optically clear adhesive are each arranged between the shading device and a respective one of the layers made of optically clear adhesive.

14. The vehicle window as claimed in claim 12, wherein the further layers made of optically clear adhesive are free of a coloring.

15. The vehicle window as claimed in a claim 1, wherein the layers made of optically clear adhesive are each arranged between two further plastics films.

16. The vehicle window as claimed in claim 1, wherein at least one of the layers made of optically clear adhesive has a refractive index which differs by less than 0.2.

17. The vehicle window as claimed in claim 5, wherein the layer made of optically clear adhesive, which is provided with the coloring, has a thickness of between 0.5 μm and 25 μm.

18. The vehicle window as claimed in claim 16, wherein at least one of the layers made of optically clear adhesive has a refractive index which differs by less than 0.1 from the refractive index of the layers adjacent to this layer made of optically clear adhesive.

19. The vehicle window as claimed in claim 16, wherein at least one of the layers made of optically clear adhesive has a refractive index which differs by less than 0.05 from the refractive index of the layers adjacent to this layer made of optically clear adhesive.

20. The vehicle window as claimed in claim 2, wherein the color particles are formed from ceramic nanoparticles.
